(19) United States
(12) Patent Application Publication
(10) Pub. No.: US 2025/0299458 A1
(43) Pub. Date: Sep. 25, 2025

(54) METHODS FOR OBJECT DETECTION IN IMAGE DATA

(71) Applicant: Robert Bosch GmbH, Stuttgart (DE)

(72) Inventors: Eduardo Monari, Karlsruhe (DE); Karim Guirguis, Stuttgart (DE); Matthias Kayser, Karlsbad (DE); Mingyang Wang, Muenchen (DE)

(21) Appl. No.: 19/070,849

(22) Filed: Mar. 5, 2025

(30) Foreign Application Priority Data
Mar. 19, 2024 (DE) 10 2024 202 568.2

(51) Int. Cl. G06V 10/25; B25J 9/16; G06V 10/40; G06V 10/764; G06V 10/776; G06V 10/82; G06V 20/56

(52) U.S. Cl. CPC G06V 10/25; B25J 9/1697; G06V 10/40; G06V 10/764; G06V 10/776; G06V 10/82; G06V 20/56

(57) ABSTRACT

A method for object detection in image data. The method includes extracting features from image data, ascertaining one or more proposals for bounding boxes for a particular object from the extracted features, and correcting the bounding boxes through a sequence of processing stages, wherein epistemic uncertainty is taken into account by means of a plurality of different passes through the processing stages.

### FIELD

The present invention relates to a method for object detection in image data.

### BACKGROUND INFORMATION

Object detection (in particular in images) is a common task in the context of autonomously controlling robotic devices, such as robotic arms and autonomous vehicles. For example, a controller for a robotic arm should be able to recognize an object to be picked up by the robotic arm (e.g., among multiple different objects), and an autonomous vehicle must be able to recognize other vehicles, pedestrians and stationary obstacles.

One approach for object detection in images, in particular for “new” classes for which few training examples are available (in addition to “base classes” for which many training examples are available), is G-FSOD (generalized few-shot object detection). G-FSOD frameworks are usually based on a two-stage Faster R-CNN (region-based convolutional neural network) model. One of the biggest bottlenecks in such object detection is typically the poor quality of the object proposals that are generated and processed in the particular machine learning model. With G-FSOD, the quality of proposals continues to deteriorate as new classes are introduced. The main reasons for this are: (1) the amount of training data (training examples) for these new classes is small and the training data as a whole therefore do not represent the actual class distribution, (2) the new classes may be considered as background by the model because the IoU (Intersection over Union) with the ground truth bounding boxes (i.e., the ground truth information about the bounding boxes that is present in the training data) is low, and (3) the scale distribution of the new objects is different from that in the base training data. Furthermore, the few training examples for the new classes lead to higher epistemic uncertainty because the true data distribution is not fully captured, causing the machine model to over- or underfit the data.

Therefore, approaches that allow for improved object detection (in particular in a G-FSOD framework) are desirable.

### SUMMARY

According to various example embodiments of the present invention, a method for object detection in image data is provided, including:
extracting features from image data (e.g., ascertainment of feature maps at different resolutions, e.g., by means of a neural convolution network);
ascertaining one or more proposals for bounding boxes for a particular object from the extracted features;
correcting the bounding boxes through a sequence of processing stages, each containing a neural network and each receiving one or more bounding box proposals as input and ascertaining a particular bounding box correction for each input bounding box proposal in one pass through the processing stage, wherein, for each processing stage,
   for each input bounding box proposal, a plurality of bounding box corrections (e.g., offsets for the indication of a bounding box or even a completely new indication for a bounding box, wherein a bounding box is indicated, e.g., by the position of a corner (e.g., top left), its height and its width) are ascertained by performing a plurality of passes for the one or more bounding box proposals input, which differ by different deactivations of neurons of the neural network (i.e., a dropout is performed during the passes in the neural network so that the passes differ),
   the output bounding box correction is ascertained for each input bounding box proposal by averaging the bounding box corrections ascertained for the input bounding box proposal in the passes.

The method of the present invention described above allows for the consideration of epistemic uncertainty in a G-FSOD framework and thus increases the performance of object detection. Aleatoric uncertainty can also be taken into account.

The corrected bounding box proposals (optionally with associated classification) can be the result of object detection or can be further processed (e.g., each corrected bounding box can be further segmented to separate the object from the background).

The refinement stages can also output a classification for each bounding box correction, i.e., one or more classification values (“scores,” e.g., logits) that predict the class of an object contained in the particular bounding box. In addition, the refinement stages can also output uncertainties (e.g., scatter or variances) for the bounding box correction(s) and, optionally, the classification(s). From these, a probability distribution for the bounding box position or the classification can then be formed.

Various exemplary embodiments of the present invention are specified below.

Exemplary embodiment 1 is a method for object detection as described above.

Exemplary embodiment 2 is a method according to exemplary embodiment 1, wherein each processing stage ascertains an associated classification for each bounding box correction in each pass, and a classification is ascertained for each input bounding box proposal by averaging the classifications ascertained for the input bounding box proposal in the passes.

This also takes into account the epistemic uncertainty regarding classifications, which further enhances object detection (including classification).

Exemplary embodiment 3 is a method according to exemplary embodiment 1 or 2, wherein each processing stage also receives the extracted features as input.

Each processing stage can thus access the extracted features, which increases the quality of object detection.

Exemplary embodiment 4 is a method according to one of exemplary embodiments 1 to 3, comprising training at least one of the processing stages that outputs the indication of a bounding box probability distribution with regard to the position of the particular bounding box for each input bounding box proposal, ascertaining bounding box samples by sampling a plurality of times from the bounding box probability distribution, determining a loss between the bounding box samples and a bounding box ground truth information (i.e., e.g., ascertaining the loss per sample (relative to a (e.g., closest) ground truth bounding box) and averaging over the losses or summing the losses), and training the at least one processing stage to reduce the loss (i.e., adjusting parameter values, typically weights, of the processing stage in a direction in which the loss is reduced, e.g., according to a gradient of the loss, typically using back propagation).

This takes into account the aleatoric uncertainty regarding the bounding boxes during training, which further improves object detection.

Exemplary embodiment 5 is a method according to one of exemplary embodiments 1 to 4, comprising training at least one of the processing stages that outputs the indication of a classification probability distribution with regard to the class of an object contained in the particular bounding box for each input bounding box proposal, ascertaining classification samples by sampling a plurality of times from the classification probability distribution, determining a loss between the classification samples and a classification ground truth information (i.e., e.g., ascertaining the loss per sample and averaging over the losses or summing the losses), and training the at least one processing stage to reduce the loss (i.e., adjusting parameter values, typically weights, of the processing stage in a direction in which the loss is reduced, e.g., according to a gradient of the loss, typically using back propagation).

This takes into account the aleatoric uncertainty regarding the classifications during training, which further improves object detection.

Exemplary embodiment 6 is a method according to one of exemplary embodiments 1 to 5, comprising ascertaining the one or more proposals for bounding boxes from the extracted features by means of a keypoint-based region proposal network.

In contrast to an anchor-based region proposal network (RPN), which typically provides “anchors” with fixed sizes, a keypoint-based RPN can provide more accurate spatial information and improves the alignment of extracted features with the proposals, which improves classification.

Exemplary embodiment 7 is a method according to one of exemplary embodiments 1 to 6, comprising training the processing stages, wherein, during training, each processing stage contains an attention block (e.g., a CBAM (convolutional block attention module) that processes features derived from the extracted features (e.g., by RoI pooling), which derived features are associated with the particular one or more bounding box proposals, wherein the processing stage ascertains the bounding box correction (and optionally the classification) using the processed features.

Exemplary embodiment 8 is a method for controlling a robotic device, comprising capturing image data of an environment of the robotic device, detecting (e.g., localizing and classifying) an object in the image data by means of the method according to one of exemplary embodiments 1 to 7; and controlling the robot device according to the detection of the object in the image data (i.e., in particular whether an object of a certain class has been detected or at what position it has been detected).

Exemplary embodiment 9 is a data processing apparatus (in particular a control apparatus) that is designed to perform a method according to one of exemplary embodiments 1 to 8.

Exemplary embodiment 10 is a computer program comprising commands that, when executed by a processor, cause the processor to carry out a method according to one of exemplary embodiments 1 to 8.

Exemplary embodiment 11 is a computer-readable medium storing commands that, when executed by a processor, cause the processor to carry out a method according to one of exemplary embodiments 1 to 8.

In the figures, similar reference signs generally refer to the same parts throughout the various views. The figures are not necessarily true to scale, with emphasis instead generally being placed on the representation of the principles of the present invention. In the following description, various aspects are described with reference to the figures.

### BRIEF DESCRIPTION OF THE DRAWINGS

FIG. 1 shows a vehicle according to an example embodiment of the present invention.

FIG. 2 shows a machine learning model according to an example embodiment of the present invention.

FIG. 3 shows the structure of an R-CNN (region-based convolutional neural network) stage of the machine learning model of FIG. 2 in detail.

FIG. 4 shows a flowchart, which represents a method for object detection in image data according to one example embodiment of the present invention.

### DETAILED DESCRIPTION OF EXAMPLE EMBODIMENTS

The following detailed description relates to the figures, which show, by way of explanation, specific details and aspects of this disclosure in which the present invention can be executed. Other aspects may be used, and structural, logical, and electrical changes may be performed without departing from the scope of protection of the present invention. The various aspects of this disclosure are not necessarily mutually exclusive, since some aspects of this disclosure may be combined with one or more other aspects of this disclosure to form new aspects.

Various examples of the present invention are described in more detail below.

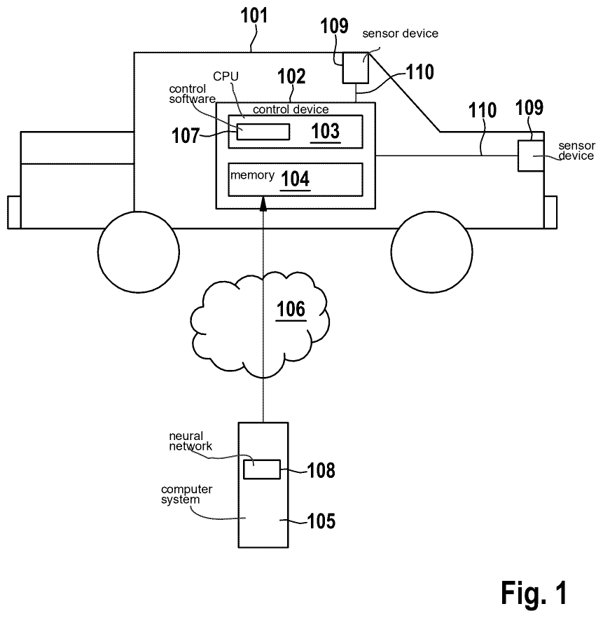

FIG. 1 shows a vehicle 101.

In the example of FIG. 1, a vehicle 101, for example a passenger car or truck, is provided with a vehicle control unit (also referred to as an electronic control unit (ECU), e.g., a control device) 102.

The vehicle control unit 102 comprises data processing components, for example a processor (for example, a CPU (central processing unit)) 103 and a memory 104 for storing control software 107 according to which the vehicle control unit 102 operates, and data that are processed by the processor 103. The processor 103 executes the control software 107.

For example, the stored control software (computer program) comprises instructions which, when executed by the processor, cause the processor 103 to perform driver assistance functions (i.e., the function of an ADAS (advanced driver assistance system)) or even to control the vehicle autonomously (AD (autonomous driving)).

The control software 107 is, for example, transmitted to the vehicle 101 from a computer system 105, for example via a network 106 (or by means of a storage medium, such as a memory card). This can also take place in operation (or at least when the vehicle 101 is with the user) since the control software 107 is updated over time to new versions, for example.

The control software 107 ascertains control actions for the vehicle (such as steering actions, braking actions, etc.) from input data that are available to it and that contain information about the environment or from which it derives information about the environment (for example, by detecting other road users, e.g., other vehicles). These input data are, for example, sensor data from one or more sensor devices 109, for example from a camera of the vehicle 101, which are connected to the vehicle control unit 102 via a communication system 110 (e.g., a vehicle bus system such as CAN (controller area network)).

The control software 107 can be trained, for example by means of machine learning (ML), i.e., the control software 107 implements, for example, a neural network (NN) 108 that is trained on the basis of training data, in this example from the computer system 105. The computer system 105 thus implements an ML training algorithm for training one (or more) ML model(s) 108.

For example, the ML model (e.g., a neural network) is an ML model for detecting objects (e.g., other vehicles, etc.). Such a system can be trained using supervised training, but this requires a large amount of training data items (i.e., training examples) that are identified with labels (i.e., with ground truth information).

Collecting large-scale training data using such labeled training data items needed to train (typically data-intensive) object detection models, can be time-consuming, labor-intensive, and costly in numerous applications, such as autonomous driving and industrial automation.

The few-shot object detection (FSOD) approach attempts to obtain meaningful representations using a limited number of training examples. Generalized FSOD (G-FSOD) aims to jointly detect base classes for which many training examples exist and new classes for which only limited training examples exist. However, such approaches ignore uncertainties that affect the performance of recognizing both types of classes. However, simply integrating uncertainty estimation in a two-stage G-FSOD framework with a region proposal network (RPN) and a subsequent R-CNN (region-based convolutional neural network) results in a loss of performance.

Prediction uncertainty can be divided into aleatoric uncertainty and epistemic uncertainty. The former represents the inherent variability in the data itself, such as sensor noise. Aleatory uncertainty is usually taken into account by explicitly integrating it into the machine learning model in question (e.g., the neural network) as learnable parameters in conjunction with the predicted results. In particular, in neural networks for object recognition, epistemic uncertainty is typically accounted for by incorporating dropouts during the training phase of the model, where a portion of neurons are randomly dropped during training, creating an ensemble of models (or “ensemble model”). By examining the variance between the predictions produced by the different models of such an ensemble, the degree of epistemic uncertainty in the model can be approximately determined. Monte Carlo dropout (MC dropout) extends this approach during inference by performing a plurality of forward passes with dropout enabled and averaging the resulting predictions.

According to various embodiments, a machine learning model (in particular a G-FSOD framework) is provided that initially refines (i.e., corrects) low-quality, highly uncertain (object) proposals (i.e., for example, bounding boxes, optionally with associated classification values (or classification scores), which are determined within the machine learning model but are not yet final, i.e., do not necessarily correspond to the final predictions) in a plurality of (processing) stages (each with an R-CNN). Each stage exploits predictive aleatoric and epistemic uncertainty to produce more reliable predictions. According to various embodiments, the stages contain attention blocks during training, which allows the most meaningful spatial features of each class to be learned (even when there are few training examples).

According to various embodiments, a method is thus provided, hereinafter also referred to as UPPR (uncertainty-based progressive proposal refinement), in which an uncertainty estimation is used in conjunction with an FSOD approach to improve the object proposals, improve overall detection performance and reduce forgetting (of the detection of previously learned classes). UPPR specifically focuses on modeling prediction uncertainties within a two-stage G-FSOD framework, allowing for refinement of object proposals. This approach (especially the modeling of prediction uncertainties in G-FSOD) allows detection performance to be improved while mitigating the forgetting problem by explicitly incorporating uncertainty modeling.

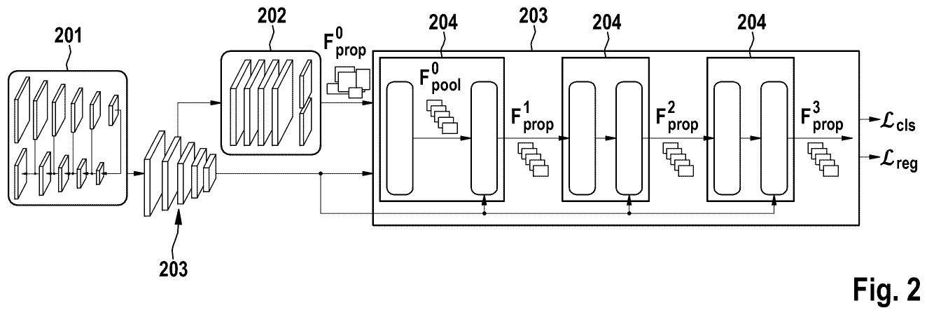

FIG. 2 shows a machine learning model 200 according to an embodiment.

In particular, the machine learning model 200 contains a plurality of R-CNN stages 204 (i.e., a sequence of (R-CNN) stages, three in the example shown), wherein the aleatoric uncertainty and the epistemic uncertainty are estimated in each R-CNN stage. Each stage (based on dropouts, see above) is considered as an ensemble model that refines the proposals based on IoU (Intersection over Union) thresholds and the estimated uncertainties. For training, increasing IoU thresholds are set (as the sequence of stages progresses) so that the later stages (i.e., the stages further back in the sequence) are more certain than the earlier ones. During training, after each R-CNN stage 204, each proposal is compared with the ground truth and the IoU is calculated. If the IoU is below the threshold (of the particular stage), the proposal is rejected. The IoU thresholds in the three stages R-CNN stages 204 are 50%, 60% and 70%, respectively. This improves predicted detections but also helps reduce base class forgetting.

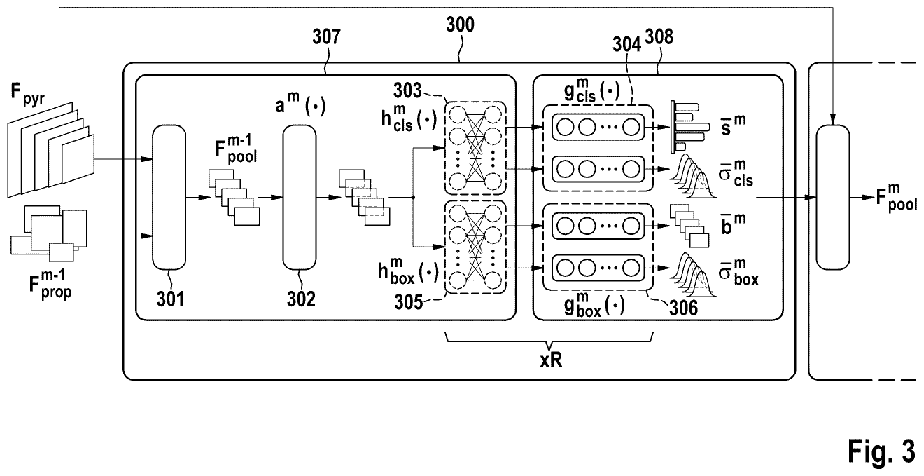

FIG. 3 shows the structure of an R-CNN stage 300 of the machine learning model 200 in detail. According to one embodiment, each of the R-CNN stages 204 has this structure.

The R-CNN stage 300 contains a RoI (Region of Interest) pooling layer 301. This is followed—only in training, not in inference—by an attention block 302. During the training phase, the R-CNN stages 200, including the attention blocks 302, are trained, for example, on a balanced set of training data elements for base classes and new classes.

The feature extractor 201 is followed by a region proposal network 202 (which, according to one embodiment, is not an anchor-based RPN but a (deeper, i.e., having more layers) keypoint-based RPN).

Using a cascaded R-CNN architecture for the machine learning model (i.e., a sequence of R-CNNs 204) instead of a single R-CNN stage in a G-FSOD framework can increase the quality of the instance-level features (i.e., for each proposal) and achieve improved overall performance in object detection.

According to G-FSOD, according to various embodiments, the training data set [symbol] ₜᵣₐᵢₙ is divided into two subsets: a base data set [symbol] _{b} having a large number of training examples for base classes [symbol] _{b} and a “new” data set [symbol] ₙ having a limited number of training examples for new classes [symbol] ₙ. It should be noted that there is no overlap between the two classes, i.e., [symbol] _{b}∩ [symbol] ₙ=0. In each training data element, an input image x∈ [symbol] is paired with a ground truth [symbol] ∈γ containing the class label [symbol] ᵢ (for the object shown in the input image) and the corresponding bounding box coordinates bᵢ, where i is the index of the training data element. The following applies to the base data set and the new data set:

$${𝒟}_{b} = ( x , y ) \vert y = ( {c}_{i} , {b}_{i} ) , {c}_{i} ∈ {𝒞}_{b}$$

$$or$$

$${𝒟}_{n} = ( x , y ) \vert y = ( {c}_{i} , {b}_{i} ) , {c}_{i} ∈ {𝒞}_{n} .$$

The G-FSOD training method comprises two stages. In the first stage, the machine learning model is trained on the basis of the base data set [symbol] _{b} to build transferable prior knowledge. In the second phase, the machine learning model uses the acquired knowledge to quickly learn new classes from [symbol] ₙ together with (a few) training examples of (basic) training examples from [symbol] _{b}. In contrast to FSOD, the primary goal of G-FSOD is to maximize the overall average precision (AP), which is a weighted average of the AP of the base classes (bAP) and the AP of the new classes (nAP), i.e.

$$AP = \vert {𝒞}_{b} \vert \cdot bAP + \vert {C}_{n} \vert \cdot nAP / ( \vert {𝒞}_{b} \vert + \vert {𝒞}_{n} \vert )$$

In the following, the components of the machine learning model 200 shown in FIG. 2 and FIG. 3 are described in more detail.

The RPN 202 is a multiscale keypoint-based RPN. An anchor-based RPN in the form of a class-independent module having, for example, a three-layer architecture typically produces inferior proposals for the subsequent R-CNN detector 205 (which is formed by the sequence of R-CNN stages 204). The problem arises from the dependence on fixed-size anchors, which can lead to numerous proposals for the background and poor-quality proposals for the foreground. In addition, the misalignment of the anchors and the convolution features complicates the classification of the bounding boxes.

On the other hand, keypoint-based approaches promise to mitigate the above limitations by representing each object using a keypoint and thus providing more accurate spatial information. Therefore, according to various embodiments, the anchor-based

RPN is replaced by a keypoint-based CenterNet (referred to as CenterNet-RPN). To explicitly account for object size variability, the feature extractor 201 contains a feature pyramid neural network (FPN). This facilitates the refinement of object proposals at different scales (e.g., in the form of a bounding box proposal for each resolution). The output 203 of the feature extractor 201 is accordingly a set of feature maps for different resolutions, i.e., a feature pyramid F_{pyr}.

The RPN 202 outputs proposals that are refined by the cascaded R-CNNs 204 (which include increasing IoU thresholds over the course of the sequence). Each R-CNN stage 204 (index m) improves the quality of the object proposals from the previous stage Fₚᵣₒₚ^{m-1} (or in the case of the first R-CNN stage 204, that of the RPN 202), thus increasing the number of true positive results that are passed on to the next stage 204 (or the output in the case of the last stage 204). Within each R-CNN stage 204, 300, classification features (index “cls”) and localization features (index “box”) are decoupled by introducing dual classification and bounding box regressor heads, i.e., each R-CNN stage 300 contains a first MLP 303 (multi-layer preceptron) and a first output layer 304 for classification (i.e., generation of class scores), as well as a second MLP 305 and a second output layer 306 for localization (i.e., determination of the bounding boxes e.g., in the form of bounding box offsets, i.e., bounding box corrections).

RoI pooling 301 “fills” each proposal from the previous stage with features from the feature pyramid F_{pyr} that each R-CNN stage 204 receives as input. The output of the ROI pooling 301 for the m-th stage is denoted by Fₚᵣₒₚ^{m-1}.

During training, each R-CNN stage 300 contains the attention block 302 so that multi-level attention is realized at the instance level, i.e., from Fₚᵣₒₚ^{m-1} for each proposal. The motivation for this is that while feeding instance-level features to the cascaded R-CNN stages 204 helps to refine the proposals, not all instance-level features are of equal importance. In order to give more weight to the features that correlate with correct classification, the attention blocks (or “modules”) 302 are provided.

The attention module 302 is, for example, a convolutional block attention module (CBAM) for selectively focusing on the most important features for the G-FSOD task. In particular, the channel and spatial attention components of CBAM capture both channel and spatial relationships between instance-level features (e.g., there are multiple image channels, such as a color or depth channel), allowing the machine learning model 200 to better capture semantically rich information for both the new and base classes. Another advantage of CBAM for object detection in a G-FSOD framework is its lightweight design, which is particularly important since it is integrated into each R-CNN stage 204. To prevent CBAM from favoring the base classes over the new classes, multi-level attention blocks are only added during the training phase for the new classes to ensure a balanced representation of the features of the base classes and the new classes.

As mentioned above, there are inherent data and model uncertainties (i.e., aleatoric and epistemic uncertainties) that are taken into account according to various embodiments to reduce forgetting and improve the detection of new classes. For this purpose, the aleatoric uncertainty and the epistemic uncertainty are estimated in each stage 204 of the cascade R-CNN. Finally, stage-by-stage refinement (of object proposals) is performed on the basis of epistemic uncertainty and on the basis of aleatoric uncertainty.

Stage-by-stage refinement based on epistemic uncertainty: During inference, epistemic uncertainty is modeled by using dropout layers (represented by dashed neurons in FIG. 3) in each R-CNN stage 204.

In the m-th R-CNN stage 300, the processing process for a training example receives the feature pyramid F_{pyr} (i.e., feature maps for a plurality of different resolutions) generated by the feature extractor network 201 (which can be seen as a backbone network), as well as the object proposals Fₚᵣₒₚ^{m-1} generated by the previous stage (or in the case of the first stage by the RPN 202, i.e., the RPN 202 can be seen as the zeroth stage). The proposal features are then extracted using RoI pooling 301, passed through the CBAM attention block 302 to be focused, and fed to the classification head 303, 304 and to the bounding box regressor head 305, 306 to obtain the class scores and bounding box offsets.

This processing is a single forward pass through the R-CNN stage 300. During testing and inference, the dropout layers are activated and R of such forward passes are performed per stage 204, each time aggregating the predictions (classification scores and bounding box offsets (to an aggregated classification score s̅^{m} and an aggregated bounding box offset (vector) b̅^{m}, see FIG. 3), and forwarded to the next stage (or output in the case of the last stage).

Formally, for M stages 204, the classification features for the m-th stage are designated as follows:

$${F}_{cls}^{m} = {h}_{cls}^{m} ( {a}^{m} ( {F}_{pool}^{m - 1} ) ) \qquad ( 1 )$$

where a^{m}(·) is the m-th stage CBAM attention module. h_{cls}^{m} is the MLP 303 of the classification head in the RoI head 307.

Similarly, the bounding box features are calculated as follows:

$${F}_{box}^{m} = {h}_{box}^{m} ( {a}^{m} ( {F}_{pool}^{m - 1} ) ) \qquad ( 2 )$$

where h_{box}^{m} is the MLP 305 in the bounding box head in the RoI head 307.

F_{cls}^{m} and F_{box}^{m} are then used by the output layers 304 and 306, respectively, denoted by g_{cls}^{m}(·) or g_{box}^{m}(·) in the RoI predictor 308, to calculate the classification scores and bounding box regression offsets (and with associated aleatoric uncertainties (variances) σ_{cls}² and (σₓ², σ_{y}², σ_{w}², σₕ²) (or represented as covariance matrices Σ_{cls}^{m} as or Σ_{box}^{m})) (said classification scores and bounding box regression offsets are output by the output layers 304, 306). As described above, during inference, R forward passes with dropouts are performed, and the classification scores (e.g., classification logits) and the bounding box offsets are aggregated. This is also done for the corresponding aleatoric variances, i.e., those of Σ_{cls}^{m} are aggregated (via the R passes) into Σ̅_{cls}^{m}, and those of Σ_{box}^{m} (via the R passes) into Ē_{box}^{m}.

The following therefore applies:

$$\begin{matrix}( {\overline{s}}_{cls}^{m} , {\overline{Σ}}_{cls}^{m} ) = \frac{1}{R} {\sum }_{r = 1}^{R} {g}_{cls}^{m} ( {F}_{cls}^{m , r} ) \\ and & ( 3 ) \\ ( {\overline{b}}_{box}^{m} , {\overline{Σ}}_{box}^{m} ) = \frac{1}{R} {\sum }_{r = 1}^{R} {g}_{box}^{m} ( {F}_{box}^{m , r} ) & ( 4 )\end{matrix}$$

where F_{cls}^{m,r} denotes the classification features output by the RoI head 307 (i.e., MLP 307) for the r-th forward pass and F_{box}^{m,r} denotes the bounding box features output by the RoI head 307 (i.e., MLP 308) for the r-th forward pass, wherein these features for classification and bounding box regression may differ from pass to pass due to the stochastic dropouts.

Stage-by-stage refinement based on aleatoric uncertainty: Aleatoric uncertainty is taken into account for both classification and bounding box regression. For this purpose, the classification scores are modeled as a multivariate Gaussian distribution, which is parameterized by the mean S_{cls} of the predicted classification scores and the diagonal corresponding covariance matrix Σ_{cls}^{m} and is calculated from the predicted class variances Σ_{cls}². N_{cls} classification scores s_{cls}^{[n]} are then drawn (i.e., sampled) from the Gaussian distribution thus generated. The resulting matrix, which contains all the samples generated in this way, is denoted by S_{cls}:

$${S}_{cls} = {\{ {s}_{cls}^{[ n ]} \}}_{n = 1}^{{N}_{cls}} ∈ {ℝ}^{{N}_{cls} \times \vert 𝒞 \vert} , {s}_{cls}^{[ n ]} \sim 𝒩 ( {s}_{cls} , {Σ}_{cls} )$$

The classification loss is then the softmax cross entropy between these stochastic classification logits S_{cls} and the associated ground truth classification labels.

The classification loss (and also the regression loss) is compared to the ground truth for each stage during training. The loss (classification loss plus regression loss) is calculated for each R-CNN stage and then averaged across the R-CNN stages to ascertain a particular training loss.

The bounding box regression results (i.e., offsets) are similarly modeled as a Gaussian distribution, wherein the mean is the predicted box offsets b_{box} and the diagonal covariance matrix Σ_{box} is ascertained from the predicted box offset variances (σₓ², σ_{y}², σ_{w}², σₕ²). From this distribution, samples are again taken and averaged and the bounding box regression loss (relative to ground truth) is ascertained, for example using a negative log likelihood.

In summary, the procedure is as follows: First, for each training example, the initial proposals of the RPN 202 are sent to the first R-CNN stage together with the feature maps generated by the feature extractor 201. Next, the first-stage RoI head 307 pools the features and extracts classification and bounding box features that are passed through the RoI predictor 308, resulting in classification scores and variances as well as bounding box offsets and variances. To capture epistemic uncertainty, stochasticity is introduced through dropout layers during training. During inference, R forward passes are performed and the network predictions are aggregated and averaged to obtain the final predictions. The predicted bounding box offsets are then applied to the input proposals, resulting in refined (i.e., corrected) boxes that serve as input to the next R-CNN stage. This stage-by-stage refinement produces more reliable boxes by leveraging the averaged epistemic predictions, which are more robust than predictions in a single pass.

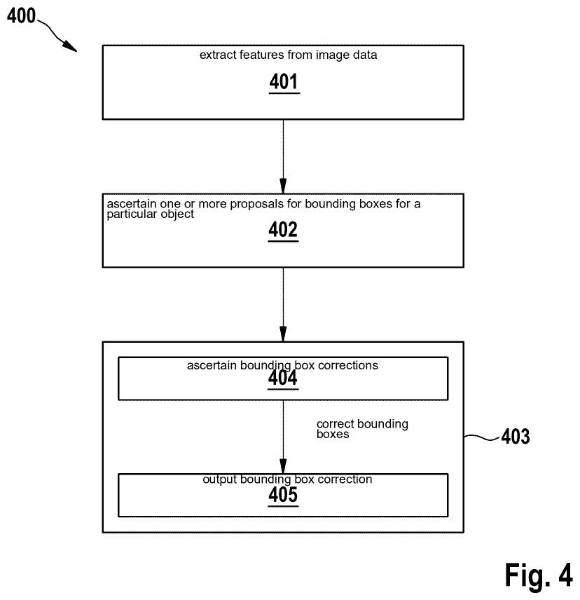

In summary, according to various embodiments, a method is provided as shown in FIG. 4.

FIG. 4 shows a flowchart 400, which represents a method for object detection in image data according to one embodiment.

In 401, features are extracted from image data (e.g., ascertainment of feature maps at different resolutions, e.g., by means of a neural convolution network).

In 402, one or more proposals for bounding boxes for a particular object are ascertained from the extracted features.

In 403, the bounding boxes are corrected (successively) through a sequence of processing stages, each containing a neural network (e.g., an MLP) and each receiving one or more bounding box proposals as input and ascertaining a particular bounding box correction for each input bounding box proposal in one pass through the processing stage (i.e., the bounding box proposals corrected according to the bounding box corrections of a processing stage serve as input for the next processing stage (unless it was the last in the sequence)), wherein, for each processing stage,
in 404, for each input bounding box proposal, a plurality of bounding box corrections (e.g., offsets for the indication of a bounding box or even a completely new indication for a bounding box, wherein a bounding box is indicated e.g., by the position of a corner (e.g., top left), its height and its width) are ascertained by performing a plurality of passes for the one or more input bounding box proposals, which differ by different deactivations of neurons of the neural network (i.e., a dropout is performed during the passes in the neural network so that the passes differ),
in 405, the output bounding box correction is ascertained for each input bounding box proposal by averaging the bounding box corrections ascertained for the input bounding box proposal in the passes.

The method of FIG. 4 can be carried out by one or more computers with one or more data processing units. The term “data processing unit” may be understood as any type of entity that allows for processing of data or signals. The data or signals can be treated, for example, according to at least one (i.e., one or more than one) special function which is performed by the data processing unit. A data processing unit can comprise or be formed from an analog circuit, a digital circuit, a logic circuit, a microprocessor, a microcontroller, a central processing unit (CPU), a graphics processing unit (GPU), a digital signal processor (DSP), an integrated circuit of a programmable gate array (FPGA) or any combination thereof. Any other way of implementing the particular functions described in more detail herein may also be understood as a data processing unit or logic circuit assembly. One or more of the method steps described in detail here can be executed (e.g., implemented) by a data processing unit by one or more special functions that are performed by the data processing unit.

The method is therefore in particular computer-implemented according to various embodiments.

Various embodiments may receive and use image data from various sensors (which may provide output data in image form), such as individual images, video, radar, LiDAR, ultrasound, motion, thermal imaging, etc. Sensor data can be measured or also simulated for periods of time (e.g., in order to generate training data elements).

In particular, these sensor data can be classified, for example to detect the presence of objects represented in the sensor data. In particular, the approach of FIG. 4 can be integrated into various frameworks in which new classes occur. In this way, the approach of FIG. 4 can be used with various AI-controlled perception systems, such as in robotics and self-driving cars.

The approach of FIG. 4 is generally used, for example, to generate a control signal for a robotic device. The term “robotic device” may be understood to refer to any technical system (comprising a mechanical part whose movement is controlled), such as a computer-controlled machine, a vehicle, a household appliance, a power tool, a manufacturing machine, a personal assistant or an access control system. A control rule for the technical system is learned, and the technical system is then controlled accordingly.

1-11. (canceled)

12. A method for object detection in image data, comprising the following steps:
extracting features from image data;
ascertaining one or more proposals for bounding boxes for a particular object from the extracted features;
correcting the bounding boxes through a sequence of processing stages, each of the processing stages containing a neural network and each neural network receiving respective one or more of the bounding box proposals as input and ascertaining a respective bounding box correction for each input bounding box proposal in one pass through the processing stage, wherein, for each processing stage:
a plurality of bounding box corrections are determined for each input bounding box proposal by performing a plurality of passes for the respective one or more input bounding box proposals, which differ by different deactivations of neurons of the neural network,
the output bounding box correction is ascertained for each respective input bounding box proposal by averaging the bounding box corrections ascertained for the input bounding box proposal in the passes.

13. The method according to claim 12, wherein each processing stage ascertains an associated classification for each bounding box correction in each pass, and the classification is ascertained for each input bounding box proposal by averaging the classifications ascertained for the input bounding box proposal in the passes.

14. The method according to claim 12, wherein each processing stage also receives the extracted features as input.

15. The method according to claim 12, further comprising:
training at least one of the processing stages that outputs the indication of a bounding box probability distribution with regard to the position of the particular bounding box for each input bounding box proposal;
ascertaining bounding box samples by sampling a plurality of times from the bounding box probability distribution;
determining a loss between the bounding box samples and a bounding box ground truth information; and
training the at least one of the processing stages to reduce the loss.

16. The method according to claim 12, further comprising:
training at least one of the processing stages that outputs the indication of a classification probability distribution with regard to the class of an object contained in the particular bounding box for each input bounding box proposal;
ascertaining classification samples by sampling a plurality of times from the classification probability distribution;
determining a loss between the classification samples and a classification ground truth information; and
training the at least one of the processing stage to reduce the loss.

17. The method according to claim 12, further comprising:
ascertaining the one or more proposals for bounding boxes from the extracted features using a keypoint-based region proposal network.

18. The method according to claim 12, further comprising:
training the processing stages, wherein, during the training, each of the processing stages contains an attention block that processes features derived from the extracted features, which derived features are associated with the respective one or more of the bounding box proposals, wherein the processing stage ascertains the bounding box correction using the processed features.

19. A method for controlling a robot device, comprising:
capturing image data of an environment of the robotic device;
detecting an object in the image data by:
extracting features from the image data,
ascertaining one or more proposals for bounding boxes for a particular object from the extracted features,
correcting the bounding boxes through a sequence of processing stages, each of the processing stages containing a neural network and each neural network receiving respective one or more of the bounding box proposals as input and ascertaining a respective bounding box correction for each input bounding box proposal in one pass through the processing stage, wherein, for each processing stage:
a plurality of bounding box corrections are determined for each input bounding box proposal by performing a plurality of passes for the respective one or more input bounding box proposals, which differ by different deactivations of neurons of the neural network,
the output bounding box correction is ascertained for each respective input bounding box proposal by averaging the bounding box corrections ascertained for the input bounding box proposal in the passes; and
controlling the robotic device according to the detection of the object in the image data.

20. A data processing apparatus configured for object detection in image data, the data processing apparatus configured to:
extract features from image data;
ascertain one or more proposals for bounding boxes for a particular object from the extracted features;
correct the bounding boxes through a sequence of processing stages, each of the processing stages containing a neural network and each neural network receiving respective one or more of the bounding box proposals as input and ascertaining a respective bounding box correction for each input bounding box proposal in one pass through the processing stage, wherein, for each processing stage:
a plurality of bounding box corrections are determined for each input bounding box proposal by performing a plurality of passes for the respective one or more input bounding box proposals, which differ by different deactivations of neurons of the neural network,
the output bounding box correction is ascertained for each respective input bounding box proposal by averaging the bounding box corrections ascertained for the input bounding box proposal in the passes.

21. A non-transitory computer-readable medium on which are stored commands for object detection in image data, the commands, when executed by a processor, causing the processor to perform the following steps:
extracting features from image data;
ascertaining one or more proposals for bounding boxes for a particular object from the extracted features;
correcting the bounding boxes through a sequence of processing stages, each of the processing stages containing a neural network and each neural network receiving respective one or more of the bounding box proposals as input and ascertaining a respective bounding box correction for each input bounding box proposal in one pass through the processing stage, wherein, for each processing stage:
a plurality of bounding box corrections are determined for each input bounding box proposal by performing a plurality of passes for the respective one or more input bounding box proposals, which differ by different deactivations of neurons of the neural network,
the output bounding box correction is ascertained for each respective input bounding box proposal by averaging the bounding box corrections ascertained for the input bounding box proposal in the passes.
